(19) United States
(12) Patent Application Publication
(10) Pub. No.: US 2015/0163747 A1
(43) Pub. Date: Jun. 11, 2015

(54) COMMON GATE BUFFER HAVING ADJUSTABLE CURRENT CONSUMPTION IN A RECEIVER

(71) Applicant: QUALCOMM Incorporated, San Diego, CA (US)

(72) Inventors: Wu-Hsin Chen, San Diego, CA (US); Gary Lee Brown, JR., Oceanside, CA (US); Chuan Wang, San Diego, CA (US); Aleksandar Miodrag Tasic, San Diego, CA (US)

(73) Assignee: QUALCOMM Incorporated, San Diego, CA (US)

(21) Appl. No.: 14/102,646

(22) Filed: Dec. 11, 2013

(51) Int. Cl. H04W 52/02; H04B 1/52

(52) U.S. Cl. CPC H04W 52/0238; H04B 1/525

(57) ABSTRACT

A device includes a common gate buffer circuit configured to receive a communication signal, an interfering signal detector configured to provide a control signal indicative of the power level of an interfering signal present with the communication signal and a control circuit configured to control an amount of current flowing through the common gate buffer circuit based on the control signal.

### BACKGROUND

1. Field

The present disclosure relates generally to electronics, and more specifically to transmitters and receivers.

2. Background

In a radio frequency (RF) transceiver, a communication signal is developed, upconverted, amplified and transmitted by a transmitter and is received, amplified, downconverted and recovered by a receiver. In the receiver, the communication signal is typically received and downconverted by receive circuitry including a filter, an amplifier, a mixer, and other components, to recover the information contained in the communication signal. Part of the function of the receiver is to perform baseband filtering on the received and downconverted signal to allow the recovery of the information contained in the signal. One receive signal filtering technique uses a common gate transistor to buffer the receive signal prior to providing the received signal to a transimpedance amplifier (TIA) having a resistive (R) and capacitive (C) filter (also referred to as an RC-TIA filter), which converts the current representing the received signal to a voltage that can then be further processed. One of the factors influencing the downconversion of the received signal is interference from a variety of sources. For example, often a transmit circuit is located on the same die as the receive circuit, and transmit power may interfere with the operation of the receiver. Other large power signals may also interfere with the operation of the receiver. These interfering signals can be referred to as “jammer signals” with jammer signals originating from transmit circuitry located near the receive circuitry referred to as “TX jammer signals.”

In such a receiver architecture, cascading an amplified (sometimes referred to as “boosted”) common gate buffer with the RC-TIA filter provides a low input impedance for the mixer and a high output impedance for the TIA. However, the bias current of the common gate buffer is determined by anticipating the presence of interfering signal jammer power. Conventional design techniques maximize the common gate bias current to compensate for the largest anticipated jammer power in a worst-case condition, which is typically much larger than a typical case. Because the jammer power is not always at maximum power, the common gate buffer need not always operate at a maximum bias current. Therefore, in situations where there is less than the anticipated maximum jammer power at the receiver, it would be desirable to reduce the common gate bias current as a way to reduce overall power consumption in the receiver.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram showing a wireless device communicating with a wireless communication system.

FIG. 2A is a graphical diagram showing an example of contiguous intra-band carrier-aggregation (CA)

FIG. 2B is a graphical diagram showing an example of non-contiguous intra-band CA.

FIG. 2C is a graphical diagram showing an example of inter-band CA in the same band group.

FIG. 2D is a graphical diagram showing an example of inter-band CA in different band groups.

FIG. 3 is a block diagram of an exemplary design of the wireless device in FIG. 1.

FIG. 4 is a schematic diagram illustrating an exemplary embodiment of a circuit that can be used to control the common gate bias current based on the power of an interfering signal.

FIG. 5 is a schematic diagram illustrating an exemplary embodiment of a circuit that can be used to control the common gate bias current based on the power of an interfering signal.

FIG. 6 is a graphical illustration showing relative interfering signal power and current buffer power consumption.

FIG. 7 is an alternative exemplary embodiment of the circuit of FIG. 4.

FIG. 8 is another alternative exemplary embodiment of the circuit of FIG. 4.

FIG. 9 is another alternative exemplary embodiment of the circuit of FIG. 4.

FIG. 10 is a schematic diagram illustrating an exemplary embodiment of the interference detector of FIG. 4.

FIG. 11 is a schematic diagram illustrating another exemplary embodiment of the interference detector of FIG. 4.

FIG. 12 is a flow chart describing the operation of an exemplary embodiment of a method that can be used to control the common gate bias current based on the power of an interfering signal.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used herein, the terms “transducer” and “transducer element” refer to an antenna element that can be stimulated with a feed current to radiate electromagnetic energy, and an antenna element that can receive electromagnetic energy and convert the received electromagnetic energy to a receive current that is applied to receive circuitry.

As used herein, the terms “jammer,” “jammer signal,” “interfering signal,” “TX jammer,” and “TX jammer signal” refer to any signal received by receive circuitry that desensitizes the receiver, or that interferes with or hinders the reception and recovery of an information signal received in a receiver.

Exemplary embodiments of the disclosure are directed toward adjusting current consumption for a common gate buffer in a receiver to control common gate bias current by detecting an interfering signal, such as a transmit (TX) jammer signal that introduces transmit power to a receiver, and tuning or adjusting the common gate bias current of the receiver based on the amount of detected interfering signal power. A feedback apparatus can also be implemented and can be digitally controlled to minimize any impact to the receiver.

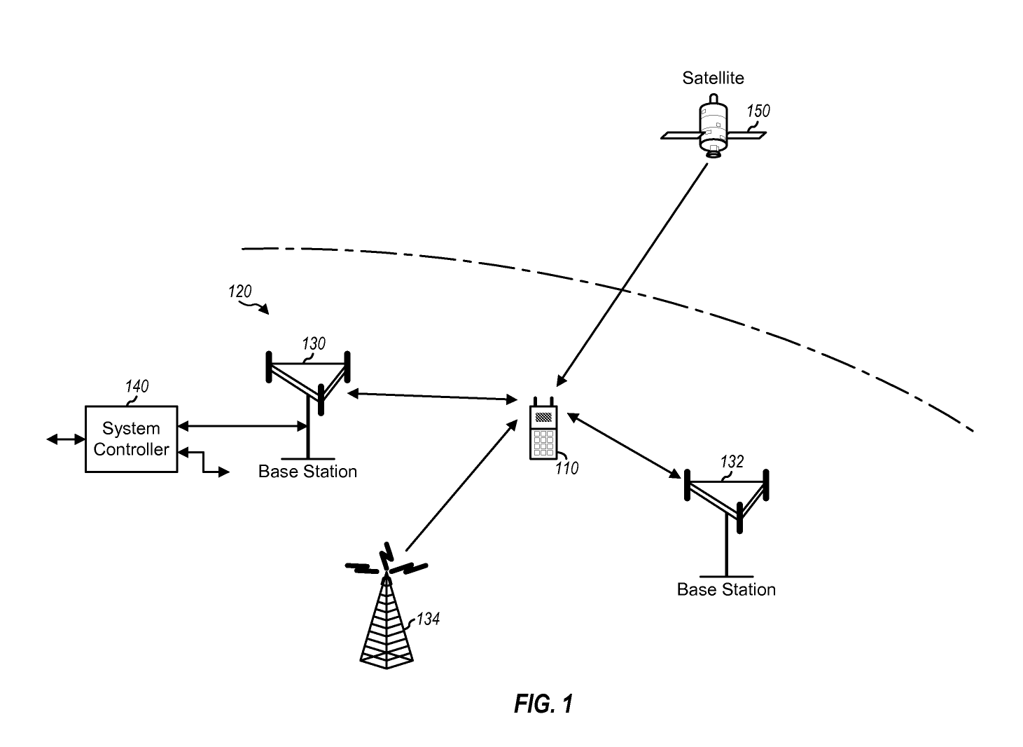

FIG. 1 is a diagram showing a wireless device 110 communicating with a wireless communication system 120. The wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless communication system may include any number of base stations and any set of network entities.

The wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. Wireless device 110 may communicate with wireless communication system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1X, EVDO, TD-SCDMA, GSM, 802.11, etc.

Wireless device 110 may support carrier aggregation, which is operation on multiple carriers. Carrier aggregation may also be referred to as multi-carrier operation. Wireless device 110 may be able to operate in low-band (LB) covering frequencies lower than 1000 megahertz (MHz), mid-band (MB) covering frequencies from 1000 MHz to 2300 MHz, and/or high-band (HB) covering frequencies higher than 2300 MHz. For example, low-band may cover 698 to 960 MHz, mid-band may cover 1475 to 2170 MHz, and high-band may cover 2300 to 2690 MHz and 3400 to 3800 MHz. Low-band, mid-band, and high-band refer to three groups of bands (or band groups), with each band group including a number of frequency bands (or simply, “bands”). Each band may cover up to 200 MHz and may include one or more carriers. Each carrier may cover up to 20 MHz in LTE. LTE Release 11 supports 35 bands, which are referred to as LTE/UMTS bands and are listed in 3GPP TS 36.101. Wireless device 110 may be configured with up to five carriers in one or two bands in LTE Release 11.

In general, carrier aggregation (CA) may be categorized into two types—intra-band CA and inter-band CA. Intra-band CA refers to operation on multiple carriers within the same band. Inter-band CA refers to operation on multiple carriers in different bands.

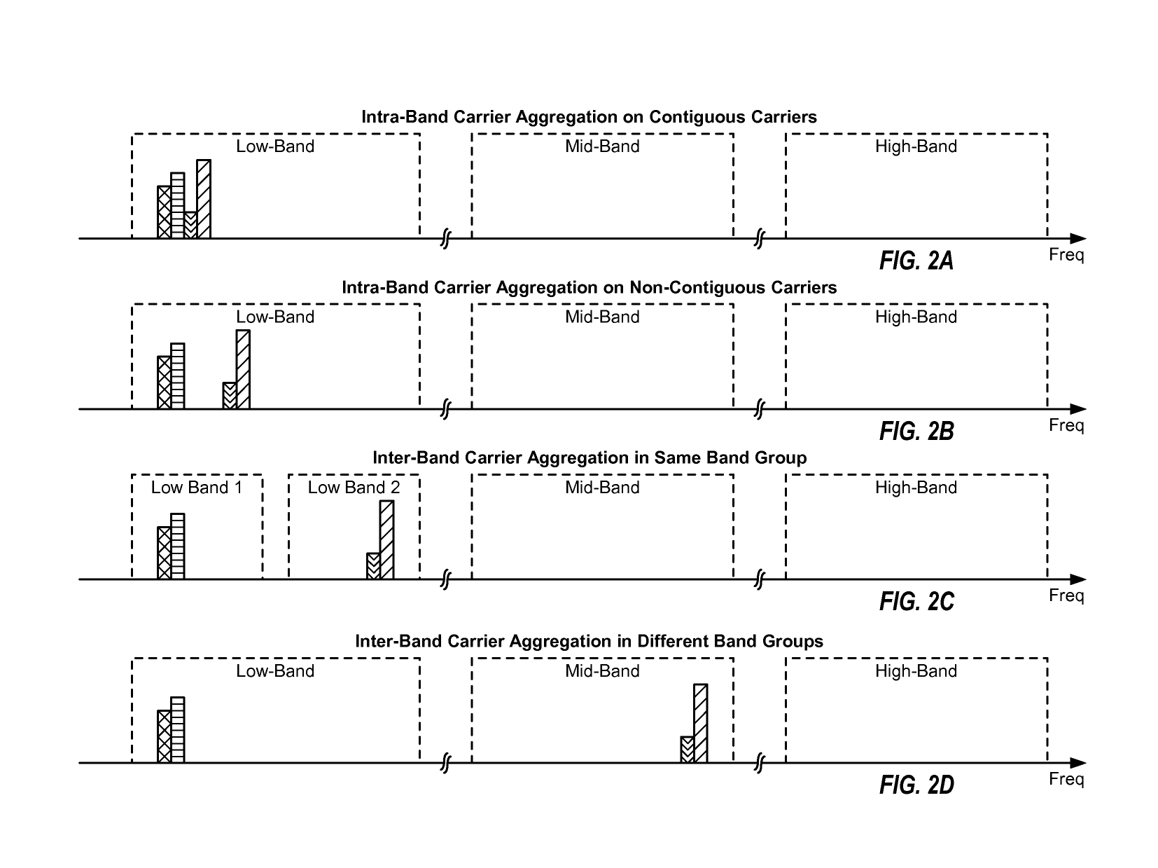

FIG. 2A is a graphical diagram showing an example of contiguous intra-band carrier-aggregation (CA). In the example shown in FIG. 2A, wireless device 110 is configured with four contiguous carriers in one band in low-band. Wireless device 110 may send and/or receive transmissions on the four contiguous carriers within the same band.

FIG. 2B is a graphical diagram showing an example of non-contiguous intra-band CA. In the example shown in FIG. 2B, wireless device 110 is configured with four non-contiguous carriers in one band in low-band. The carriers may be separated by 5 MHz, 10 MHz, or some other amount. Wireless device 110 may send and/or receive transmissions on the four non-contiguous carriers within the same band.

FIG. 2C is a graphical diagram showing an example of inter-band CA in the same band group. In the example shown in FIG. 2C, wireless device 110 is configured with four carriers in two bands in low-band. Wireless device 110 may send and/or receive transmissions on the four carriers in different bands in the same band group.

FIG. 2D is a graphical diagram showing an example of inter-band CA in different band groups. In the example shown in FIG. 2D, wireless device 110 is configured with four carriers in two bands in different band groups, which include two carriers in one band in low-band and two carriers in another band in mid-band. Wireless device 110 may send and/or receive transmissions on the four carriers in different bands in different band groups.

FIGS. 2A to 2D show four examples of carrier aggregation. Carrier aggregation may also be supported for other combinations of bands and band groups.

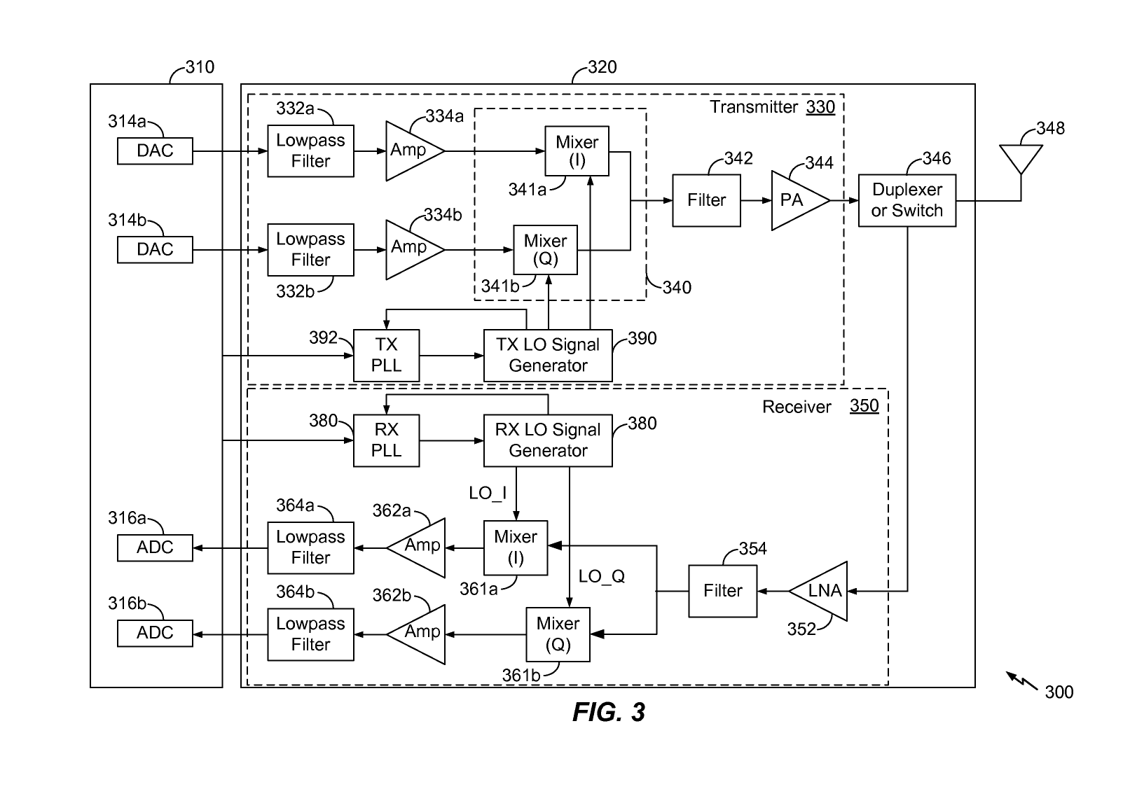

FIG. 3 is a block diagram showing a wireless communication device 300 in which the exemplary techniques of the present disclosure may be implemented. FIG. 3 shows an example of a transceiver 300. In general, the conditioning of the signals in a transmitter 330 and a receiver 350 may be performed by one or more stages of amplifier, filter, upconverter, downconverter, etc. These circuit blocks may be arranged differently from the configuration shown in FIG. 3. Furthermore, other circuit blocks not shown in FIG. 3 may also be used to condition the signals in the transmitter and receiver. Unless otherwise noted, any signal in FIG. 3, or any other figure in the drawings, may be either single-ended or differential. Some circuit blocks in FIG. 3 may also be omitted.

In the example shown in FIG. 3, wireless device 300 generally comprises a transceiver 320 and a data processor 310. The data processor 310 may include a memory (not shown) to store data and program codes, and may generally comprise analog and digital processing elements. The transceiver 320 includes a transmitter 330 and a receiver 350 that support bi-directional communication. In general, wireless device 300 may include any number of transmitters and/or receivers for any number of communication systems and frequency bands. All or a portion of the transceiver 320 may be implemented on one or more analog integrated circuits (ICs), RF ICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the example shown in FIG. 3, transmitter 330 and receiver 350 are implemented with the direct-conversion architecture.

In the transmit path, the data processor 310 processes data to be transmitted and provides in-phase (I) and quadrature (Q) analog output signals to the transmitter 330. In an exemplary embodiment, the data processor 310 includes digital-to-analog-converters (DAC's) 314a and 314b for converting digital signals generated by the data processor 310 into the I and Q analog output signals, e.g., I and Q output currents, for further processing.

Within the transmitter 330, lowpass filters 332a and 332b filter the I and Q analog transmit signals, respectively, to remove undesired images caused by the prior digital-to-analog conversion. Amplifiers (Amp) 334a and 334b amplify the signals from lowpass filters 332a and 332b, respectively, and provide I and Q baseband signals. An upconverter 340 upconverts the I and Q baseband signals with I and Q transmit (TX) local oscillator (LO) signals from a TX LO signal generator 390 and provides an upconverted signal. A filter 342 filters the upconverted signal to remove undesired images caused by the frequency upconversion as well as noise in a receive frequency band. A power amplifier (PA) 344 amplifies the signal from filter 342 to obtain the desired output power level and provides a transmit RF signal. The transmit RF signal is routed through a duplexer or switch 346 and transmitted via an antenna 348.

In the receive path, antenna 348 receives communication signals and provides a received RF signal, which is routed through duplexer or switch 346 and provided to a low noise amplifier (LNA) 352. The duplexer 346 is designed to operate with a specific RX-to-TX duplexer frequency separation, such that RX signals are isolated from TX signals. The received RF signal is amplified by LNA 352 and filtered by a filter 354 to obtain a desired RF input signal. Downconversion mixers 361a and 361b mix the output of filter 354 with I and Q receive (RX) LO signals (i.e., LO_I and LO_Q) from an RX LO signal generator 380 to generate I and Q baseband signals. The I and Q baseband signals are amplified by amplifiers 362a and 362b and further filtered by lowpass filters 364a and 364b to obtain I and Q analog input signals, which are provided to data processor 310. In the exemplary embodiment shown, the data processor 310 includes analog-to-digital-converters (ADC's) 316a and 316b for converting the analog input signals into digital signals to be further processed by the data processor 310.

In FIG. 3, TX LO signal generator 390 generates the I and Q TX LO signals used for frequency upconversion, while RX LO signal generator 380 generates the I and Q RX LO signals used for frequency downconversion. Each LO signal is a periodic signal with a particular fundamental frequency. A phase locked loop (PLL) 392 receives timing information from data processor 310 and generates a control signal used to adjust the frequency and/or phase of the TX LO signals from LO signal generator 390. Similarly, a PLL 382 receives timing information from data processor 310 and generates a control signal used to adjust the frequency and/or phase of the RX LO signals from LO signal generator 380.

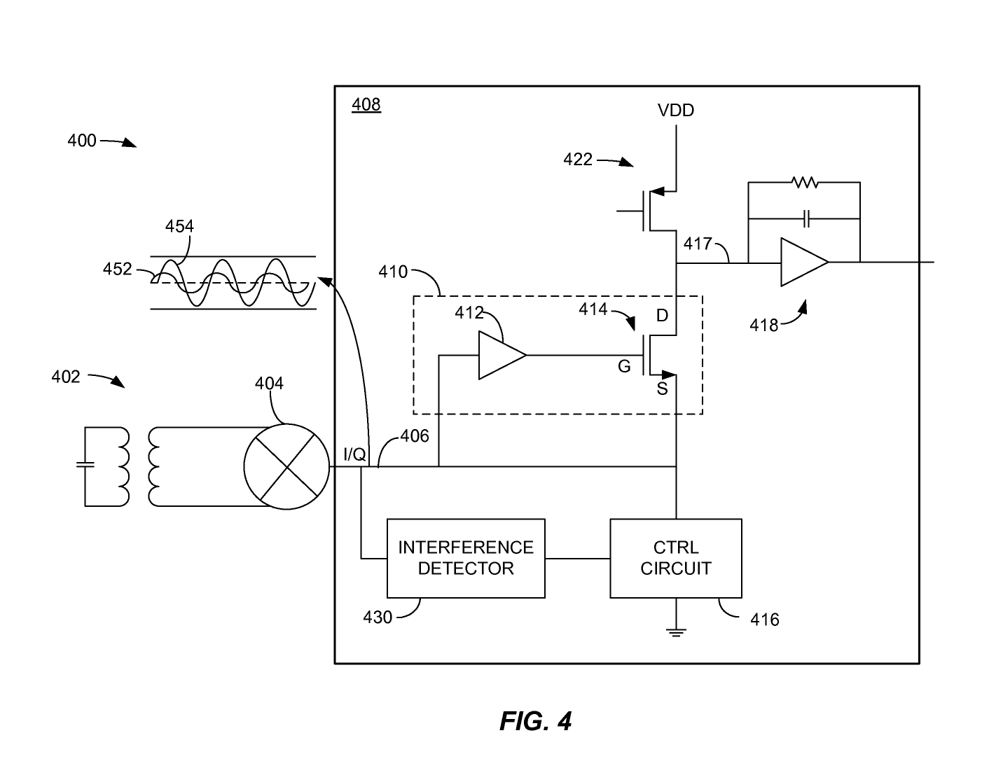

FIG. 4 is a schematic diagram illustrating an exemplary embodiment of a circuit 400 that can be used to control the common gate bias current based on the power of an interfering signal. In an exemplary embodiment, the circuit 400 shown in FIG. 4 describes a single-ended implementation of one of the filters 364a and 364b shown in FIG. 3. Those skilled in the art will recognize that two of the baseband filters 408 shown in FIG. 4 would be implemented in the transceiver 300 of FIG. 3, one to process the in-phase (I) signals and one to process the quadrature (Q) signals.

The circuit 400 comprises a simplified representation of a low noise amplifier (LNA) 402 that provides a differential receive signal to a mixer 404. The output of the mixer 404 on connection 406 is illustrated as a single-ended signal for convenience of description. In an exemplary embodiment, the mixer 404 converts the RF receive signal to a baseband information signal.

The output of the mixer 404 is provided over connection 406 to a baseband filter 408. The baseband filter 408 generally comprises a common gate buffer circuit 410, an interference detector 430, a control circuit 416, an amplifier (trans-impedance amplifier (TIA)) stage 418 having resistive and capacitive (RC) feedback, and a common mode feedback (CMFB) circuit 422.

The common gate buffer circuit 410 comprises an operational amplifier (OP-AMP) 412 and a switching device 414. The OP-AMP 412 can be configured to operate as a gain boost amplifier. In an exemplary embodiment, the switching device 414 is depicted as a field effect transistor (FET) having a gate connected to the output of the OP-AMP 412, a source connected to the control circuit 416 and a drain connected to an input of the TIA stage 418. The switching device 414 is also referred to herein as a “current buffer.” The drain of the current buffer 414 is considered the output of the common gate buffer circuit 410 and is used to drive the TIA stage 418 and to provide the baseband level communication signal on connection 406 to the input of the TIA stage 418 on connection 417. The common mode feedback circuit 422, while shown as a single-ended circuit, is used to cancel the common-mode voltage in a differential signal application.

In an exemplary embodiment, an interference detector (also referred to as a jammer detector) 430, receives the output of the mixer 404 over connection 406. The baseband signal on connection 406 may comprise the desired information signal 452 and an interfering signal 454. Typically, if present, the interfering signal 454 may be many times more powerful than the desired information signal 452 and may occur in or out of phase with the desired information signal 452. The interference detector 430 is configured to determine a power level of an interfering signal, such as interfering signal 454, present on connection 406 and provide a control signal output to the control circuit 416 based on the detected power of an interfering signal present on connection 406. In response to the control signal provided by the interference detector 430, the control circuit 416 controls the amount of current that flows through the current buffer 414. For example, in the presence of a strong interfering signal, the interference detector 430 provides a control signal to the control circuit 416 that causes the control circuit 416 to increase the amount of current flowing through the current buffer 414. However, if there is little or no interfering signal power detected by the interference detector 430, then the interference detector 430 provides a control signal to the control circuit 416 that causes the control circuit 416 to decrease the amount of current flowing through the current buffer 414, thus allowing the current buffer 414 to consume less power than it does in the presence of a strong interfering signal. In this manner, the power of an interfering signal on connection 406 is used as a way to determine an amount of current consumed by the current buffer 414.

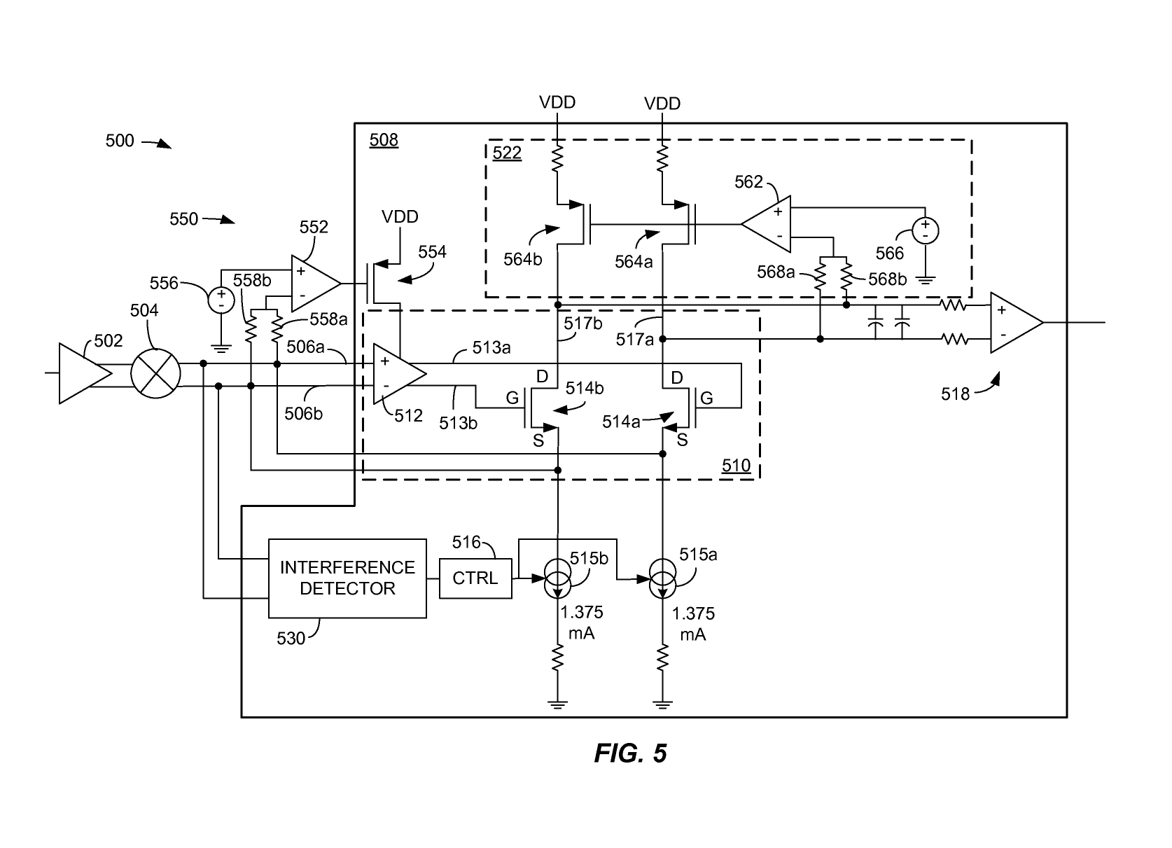

FIG. 5 is a schematic diagram illustrating an exemplary embodiment of a circuit 500 that can be used to control the common gate bias current based on the power of an interfering signal. In an exemplary embodiment, the circuit 500 shown in FIG. 5 describes a differential implementation of the baseband filter 408 of FIG. 4.

The circuit 500 comprises a simplified representation of a low noise amplifier (LNA) 502 that provides a differential receive signal to a mixer 504. The output of the mixer 504 on connections 506a and 506b is illustrated as a differential signal with the receive signal on connections 506a and 506b being represented by two complementary signals on different conductors, with the term “differential” representing the difference between the two complementary signals. The two complementary signals can be referred to as the “true” or “t” signal and the “complement” or “c” signal. All differential signals also have what is referred to as a “common mode,” which represents the average of the two differential signals. High-speed differential signaling offers many advantages, such as low noise and low power while providing a robust and high-speed data transmission.

The differential output of the mixer 504 is provided over connection 506a and 506b to a baseband filter 508. The baseband filter 508 generally comprises a common gate buffer circuit 510, an interference detector 530, a control circuit 516, an amplifier (transimpedance amplifier (TIA)) stage 518, and a common mode feedback circuit 522.

The common gate buffer circuit 510 comprises an operational amplifier (OP-AMP) 512 and switching devices 514a and 514b. The OP-AMP 512 can be configured to operate as a gain boost amplifier. In an exemplary embodiment, the switching devices 514a and 514b are each depicted as a field effect transistor (FET) having a gate connected to one of two outputs 513a and 513b of the OP-AMP 512, a source connected to one of two current sources 515a and 515b and a drain connected to one of the differential inputs 517a and 517b of the TIA stage 518. The switching devices 514a and 514b are also referred to herein as a “current buffer.” The drain of the current buffer 514a and the drain of the current buffer 514b is considered the output of the common gate buffer circuit 510 and is used to drive the TIA stage 518 and to provide the baseband level communication signal from connections 506a and 506b to connections 513a and 513b, and to connections 517a and 517b to the TIA stage 518.

The current sources 515a and 515b are controlled by a signal developed by the control circuit 516 in response to a control signal developed by the interference detector 530. In response to the control signal provided by the interference detector 530, the control circuit 516 controls the amount of current that flows through the current sources 515a and 515b and therefore, controls the amount of current that flows through the current buffers 514a and 514b.

The OP-AMP 512 is controlled by a control circuit 550 comprising an OP-AMP 552 and a switching device 554. A non-inverting input of the OP-AMP 552 is connected to a power supply 556, and the inverting input of the OP-AMP 552 is connected to the differential baseband receive signal on connections 506a and 506b through respective resistances 558a and 558b.

The common mode feedback circuit 522 comprises an OP-AMP 562 and switching devices 564a and 564b. A non-inverting input of the OP-AMP 562 is connected to a power supply 566, and the inverting input of the OP-AMP 562 is connected to the differential baseband receive signal on connections 506a and 506b through respective resistances 568a and 568b. The common mode feedback circuit 522 is used to cancel the common-mode voltage in a differential signal application.

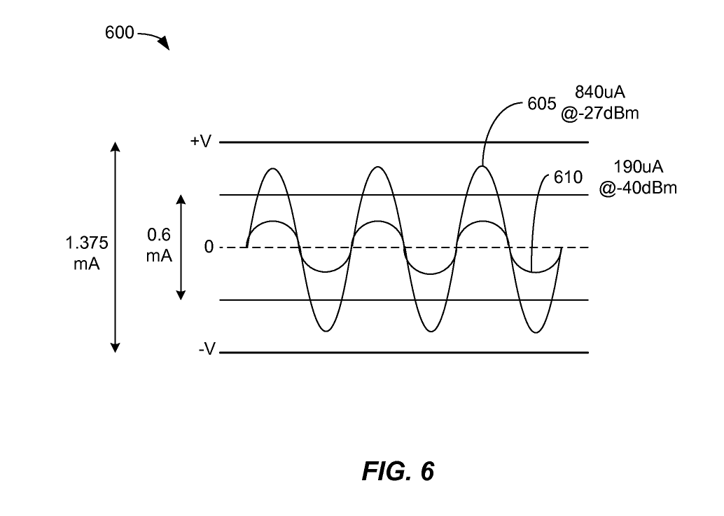

FIG. 6 is a graphical illustration showing relative interfering signal power and current buffer power consumption. While the description of FIG. 6 will make reference to the circuit of FIG. 5, this description is applicable to other exemplary embodiments of the circuits described herein that can be used to control the common gate bias current based on the power of an interfering signal.

The graph 600 shows a maximum current buffer current draw of 1.375 milliamps (mA), which is the maximum current that can be supplied by the current sources 515a and 515b of FIG. 5. A −27 dBm jammer signal is depicted using reference numeral 605 and a −40 dBm jammer is depicted using reference numeral 610. A desired receive signal is not shown for simplicity, but would generally have substantially less power than either of the jammer signals 605 or 610.

In this example, the −27 dBm jammer signal 605 corresponds to 840 microamps (μA) of current draw while the −40 dBm jammer signal 610 corresponds to 190 microamps (μA) of current draw. This illustration shows that a steady 1.375 milliamps (mA) of current through each of the current buffers 514a and 514b (FIG. 5) exceeds that which would be needed in the presence of a −40 dBm jammer signal. Therefore, it is desirable to have a way to determine jammer signal strength and adapt the current draw of the current buffer based on the strength of the jammer signal. In this example, 0.6 mA of current buffer current draw is sufficient to overcome the −40 dBm jammer signal 610. Accordingly, if the −40 dBm jammer signal 610 is detected by the interference detector 530, then the control circuit 516 would receive a control signal from the interference detector 530 instructing the control circuit 516 to reduce the current through the current sources 515a and 515b to 0.6 mA. However, if the −27 dBm jammer signal 605 is detected by the interference detector 530, then the control circuit 516 would receive a control signal from the interference detector 530 instructing the control circuit 516 to increase the current through the current sources 515a and 515b to 1.375 mA, which is sufficient in this example to overcome the −27 dBm jammer signal 605. The values of the jammer signals 605 and 610 are used as examples only.

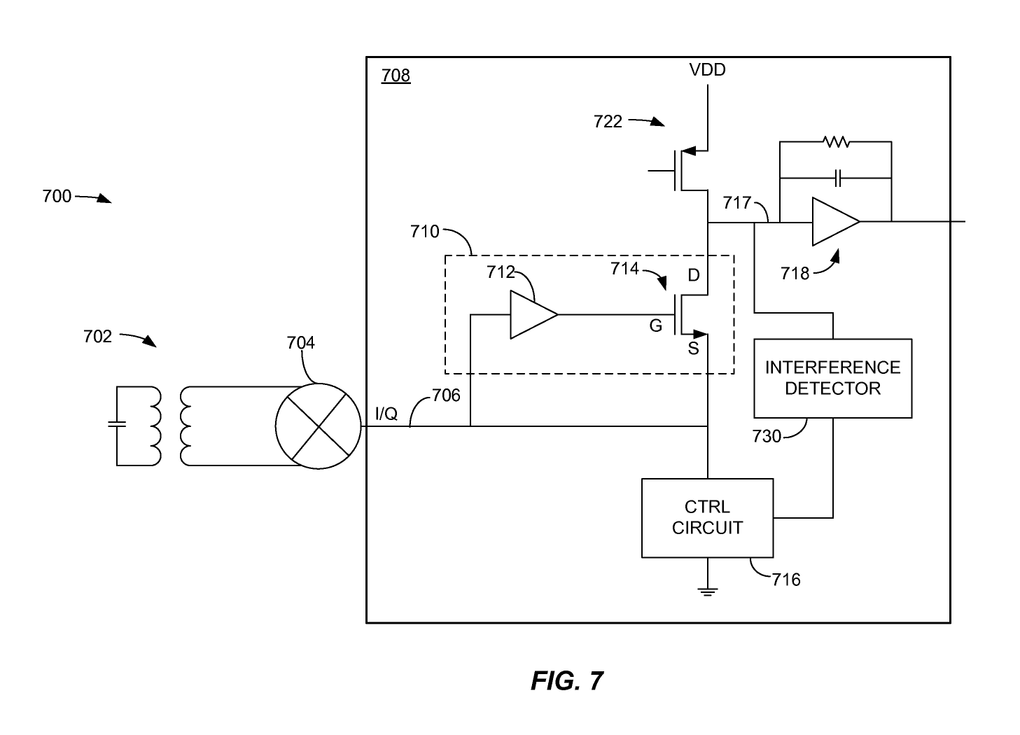

FIG. 7 is an alternative exemplary embodiment of the circuit of FIG. 4. The circuit 700 comprises a simplified representation of a low noise amplifier (LNA) 702 that provides a differential receive signal to a mixer 704. The output of the mixer 704 on connection 706 is illustrated as a single-ended signal for convenience of description. In an exemplary embodiment, the mixer 704 converts the RF receive signal to a baseband information signal.

The output of the mixer 704 is provided over connection 706 to a baseband filter 708. The baseband filter 708 generally comprises a common gate buffer circuit 710, an interference detector 730, a control circuit 716, an amplifier (trans-impedance amplifier (TIA)) stage 718 having resistive and capacitive (RC) feedback, and a common mode feedback (CMFB) circuit 722.

The common gate buffer circuit 710 comprises an operational amplifier (OP-AMP) 712 and a switching device 714. The operational amplifier (OP-AMP) 712 is similar to the OP-AMP 412 of FIG. 4 and the switching device 714 is similar to the switching device 414 of FIG. 4.

In FIG. 7, an input to the interference detector 730 is taken from the output of the common gate buffer circuit 710 on connection 717. Detecting the interfering signal power at the output of the common gate buffer circuit 710 minimizes any negative effects that could otherwise affect the mixer 704. During operation, the interference detector 730 will consume signal power so that it can evaluate the receive signal for the presence of an interfering signal. This will degrade the evaluated signal, particularly if there is no interfering signal present. In other words, the interference detector 730 creates a parasitic load on the signal path. For example, the receiver described herein operates in current mode. Any signal power sent between two circuits or two circuit portions can be related to the ratio of the output impedance of the sending circuit and the input impedance of the receiving circuit. In this example, consider the common gate buffer circuit 710 as a sending circuit, consider the mixer 704 as a sending circuit and consider the interference detector 730 as a receiving circuit. The output impedance of the common gate buffer circuit is five (5) to ten (10) times higher than the output impedance of the mixer 704. Therefore, adding extra parasitic load in the form of the interference detector 730 to the output of the common gate buffer circuit 710 has less negative impact to the received signal as compared to adding additional parasitic load to the output of the mixer 704. Locating the interference detector 730 at the output of the common gate buffer circuit 710 minimizes the effect of this parasitic load because the output of the common gate buffer circuit 710 on connection 717 offers higher output impedance compared to the output of the mixer 704.

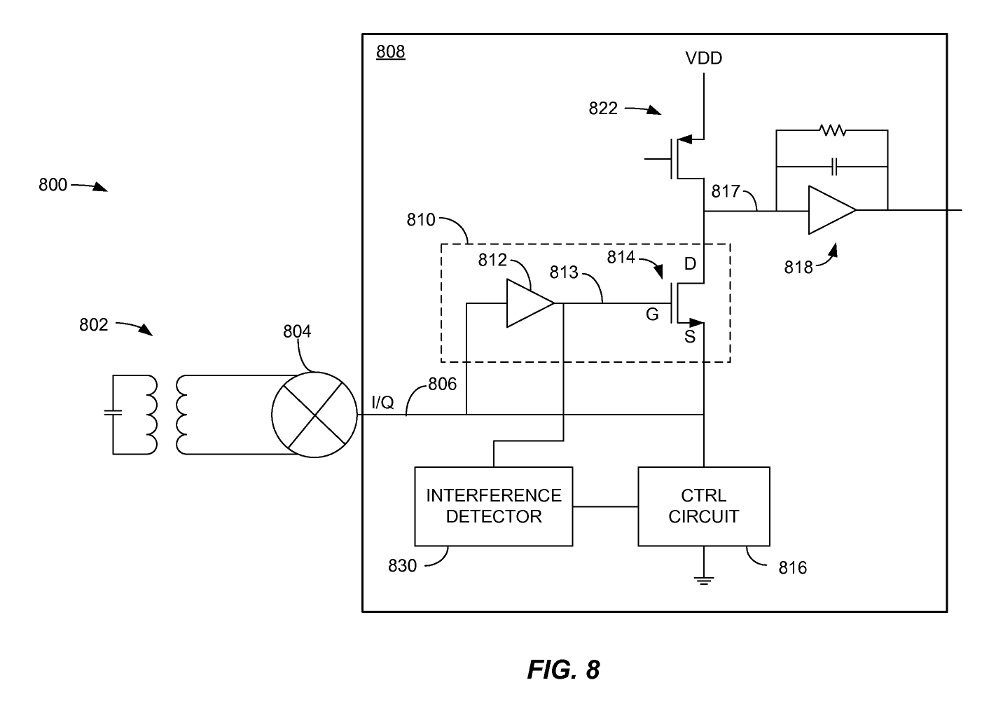

FIG. 8 is another alternative exemplary embodiment of the circuit of FIG. 4. The circuit 800 comprises a simplified representation of a low noise amplifier (LNA) 802 that provides a differential receive signal to a mixer 804. The output of the mixer 804 on connection 806 is illustrated as a single-ended signal for convenience of description. In an exemplary embodiment, the mixer 804 converts the RF receive signal to a baseband information signal.

The output of the mixer 804 is provided over connection 806 to a baseband filter 808. The baseband filter 808 generally comprises a common gate buffer circuit 810, an interference detector 830, a control circuit 816, an amplifier (trans-impedance amplifier (TIA)) stage 818 having resistive and capacitive (RC) feedback, and a common mode feedback (CMFB) circuit 822.

The common gate buffer circuit 810 comprises an operational amplifier (OP-AMP) 812 and a switching device 814. The operational amplifier (OP-AMP) 812 is similar to the OP-AMP 412 of FIG. 4 and the switching device 814 is similar to the switching device 414 of FIG. 4.

In FIG. 8, an input to the interference detector 830 is taken from the output of the OP-AMP 812 on connection 813 located in the common gate buffer circuit 810. In FIG. 8, detecting the interfering signal power at the output of the OP-AMP 812 allows the OP-AMP 812 to act as an additional buffer for the interfering signal.

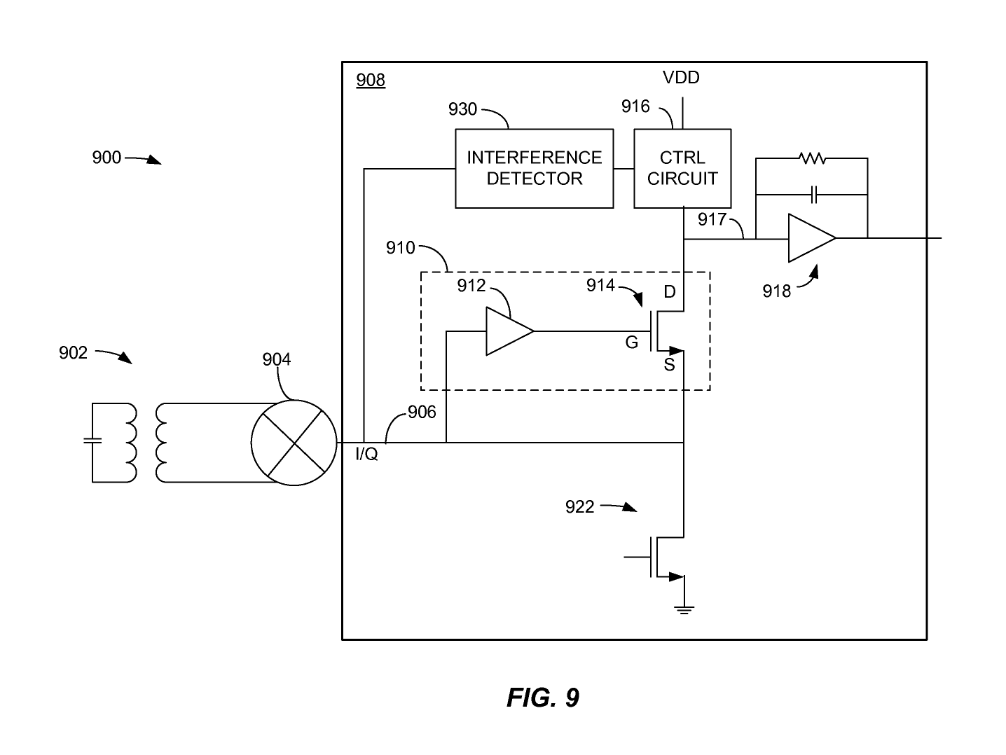

FIG. 9 is another alternative exemplary embodiment of the circuit of FIG. 4. The circuit 900 comprises a simplified representation of a low noise amplifier (LNA) 902 that provides a differential receive signal to a mixer 904. The output of the mixer 904 on connection 906 is illustrated as a single-ended signal for convenience of description. In an exemplary embodiment, the mixer 904 converts the RF receive signal to a baseband information signal.

The output of the mixer 904 is provided over connection 906 to a baseband filter 908. The baseband filter 908 generally comprises a common gate buffer circuit 910, an interference detector 930, a control circuit 916, an amplifier (trans-impedance amplifier (TIA)) stage 918 having resistive and capacitive (RC) feedback, and a common mode feedback (CMFB) circuit 922.

The common gate buffer circuit 910 comprises an operational amplifier (OP-AMP) 912 and a switching device 914. The operational amplifier (OP-AMP) 912 is similar to the OP-AMP 412 of FIG. 4 and the switching device 914 is similar to the switching device 414 of FIG. 4.

In FIG. 9, the positions of the interference detector 930, the control circuit 916 and the common mode feedback circuit 922 are moved with respect to the arrangement shown in FIG. 4. The interference detector 930 is configured to determine a power level of an interfering signal present on connection 906 and provide a control signal output to the control circuit 916 based on the detected power of an interfering signal present on connection 906. The source of the current buffer 914 is coupled to the drain of the common mode feedback device 922, and the control circuit 916 is used to control the current flowing through the current buffer 914.

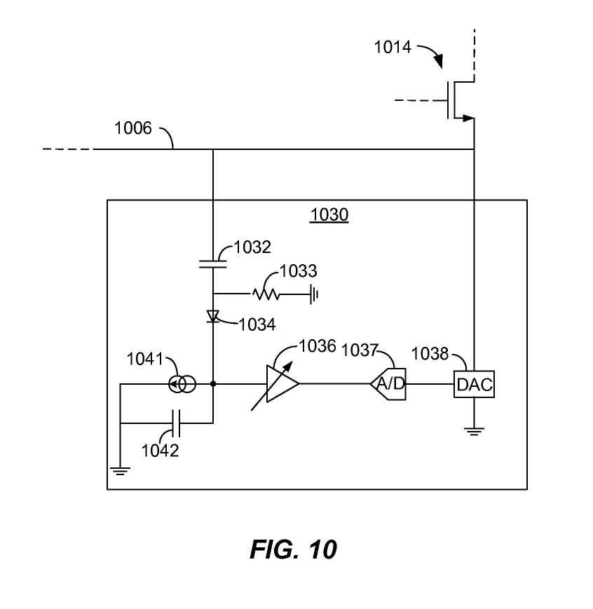

FIG. 10 is a schematic diagram illustrating an exemplary embodiment of the interference detector 430 of FIG. 4. However, the interference detector 1030 shown in FIG. 10 can be applied to any of the exemplary embodiments described herein. The interference detector 1030 comprises a capacitive element 1032, a resistive element 1033 and a diode detector 1034. The diode detector 1034 can be implemented as an envelope detector to detect the presence and amount of interfering signal power present on connection 1006.

The interference detector 1030 also comprises a variable gain amplifier 1036, an analog-to-digital converter (A/D) 1037, a digital-to-analog converter (DAC) 1038, a current source 1041 and a capacitive element 1042.

An output of the diode detector 1034 is provided as an input to the VGA 1036, the output of which is digitized by the A/D 1037. The digital output of the A/D 1037 can be used by the DAC 1038 to provide a digital signal to control the current flow through the current buffer 1014 to minimize the impact to the receiver architecture. The output of the DAC 1038 can be a current or a voltage. In an exemplary embodiment, the output of the DAC 1038 is a current, i.e., a digitally controlled current source, so the DAC 1038 operates as a control circuit and as the current source.

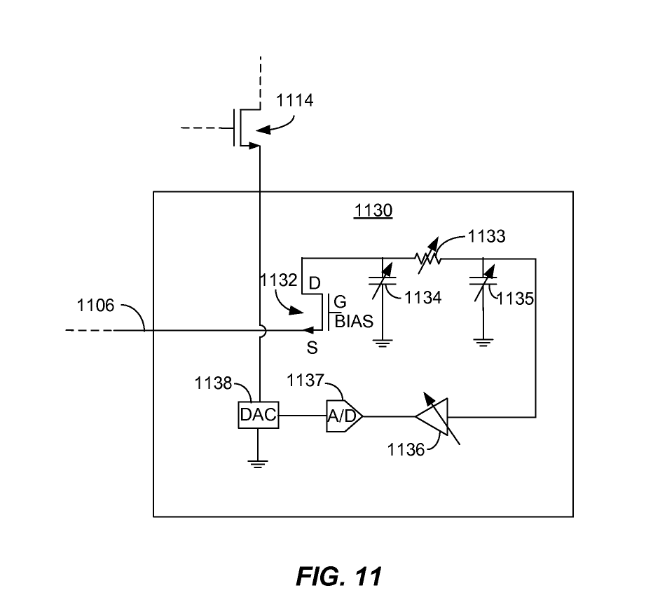

FIG. 11 is a schematic diagram illustrating another exemplary embodiment of the interference detector 430 of FIG. 4. However, the interference detector 1130 shown in FIG. 11 can be applied to any of the exemplary embodiments described herein. The interference detector 1130 comprises a switching device 1132 having its source coupled to the output of the mixer (not shown) on connection 1106. The drain of the switching device 1132 is coupled to an adjustable RC network comprising an adjustable resistance 1133 and adjustable capacitances 1134 and 1135. The connected node of the adjustable resistance 1133 and adjustable capacitance 1135 is coupled to an input of a variable gain amplifier 1136, the output of which is digitized by the A/D 1137. The digital output of the A/D 1137 can be used by the DAC 1138 to provide a digital signal to control the current flow through the current buffer 1114 to minimize the impact to the receiver architecture. The output of the DAC 1138 can be a current or a voltage. In an exemplary embodiment, the output of the DAC 1138 is a current, i.e., a digitally controlled current source, so the DAC 1138 operates as a control circuit and as the current source. Other embodiments of interference detectors are possible, with the two exemplary embodiments shown in FIG. 10 and in FIG. 11 being examples only.

The switching device 1132 having its source coupled to the output of the mixer on connection 1106 operates in a similar manner as the current buffer 414 (FIG. 4), except that the switching device 1132 is physically smaller than the current buffer 414 (FIG. 4). An interfering signal on connection 1106 will also pass through the switching device 1132, and therefore, can be measured at the drain of the switching device 1132 to measure the power of the interfering signal. Because the switching device 1132 also provides a certain amount of isolation, the tunable band-pass filter comprising the adjustable resistance 1133 and the adjustable capacitances 1134 and 1135 can be used to determine which frequency is to be measured for an interfering signal, providing an additional degree of controllability compared to the interference detector shown in FIG. 10. The bias voltage of the switching device 1132 determines the sensitivity of the switching device 1132, and is typically a tunable voltage generated from an on-chip voltage DAC (not shown).

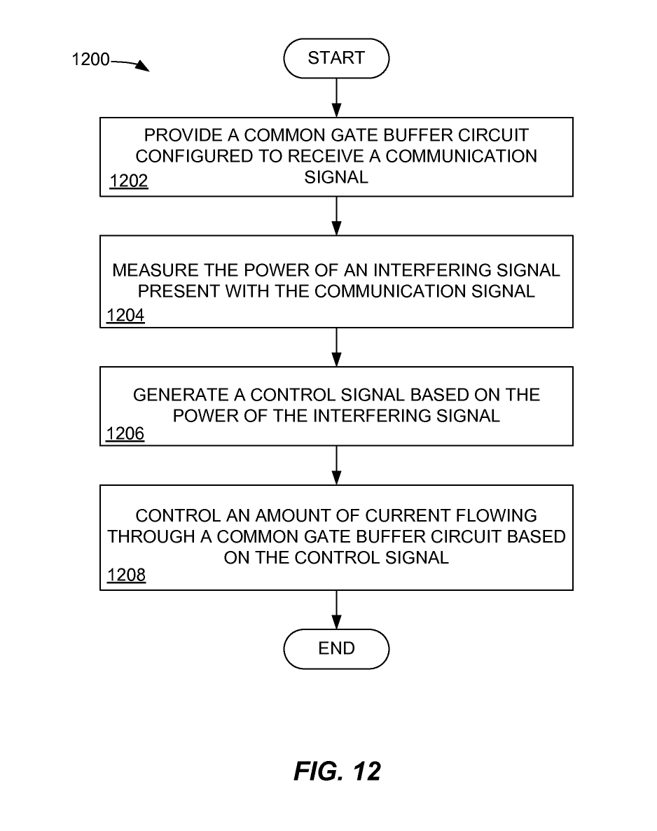

FIG. 12 is a flow chart describing the operation of an exemplary embodiment of a method that can be used to control the common gate bias current based on the power of an interfering signal.

In block 1202, a common gate buffer circuit configured to receive a communication signal is provided.

In block 1204, the power of an interfering signal is measured by an exemplary embodiment of the interference detector described above.

In block 1206, a control signal is generated based on the detected power of the interfering signal.

In block 1208, the control circuit controls the amount of current flowing through the common gate buffer circuit based on the control signal.

The common gate bias current circuit described herein may be implemented on one or more ICs, analog ICs, RFICs, mixed-signal ICs, ASICs, printed circuit boards (PCBs), electronic devices, etc. The common gate bias current circuit may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the common gate bias current circuit described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Although selected aspects have been illustrated and described in detail, it will be understood that various substitutions and alterations may be made therein without departing from the spirit and scope of the present invention, as defined by the following claims.

What is claimed is:

1. A device, comprising:
a common gate buffer circuit configured to receive a communication signal;
an interfering signal detector configured to provide a control signal indicative of the power level of an interfering signal present with the communication signal; and
a control circuit configured to control an amount of current flowing through the common gate buffer circuit based on the control signal.

2. The device of claim 1, wherein an input to the interfering signal detector is taken from an input to the common gate buffer circuit.

3. The device of claim 1, wherein an input to the interfering signal detector is taken from an output of the common gate buffer circuit.

4. The device of claim 1, wherein the common gate buffer circuit comprises an operational amplifier (OP-AMP) and a current buffer, and an input to the interfering signal detector is taken from the output of the OP-AMP.

5. The device of claim 1, wherein an input to the interfering signal detector is taken from an input of the common gate buffer circuit and the control circuit is located at an output of the common gate buffer circuit.

6. The device of claim 1, wherein the interfering signal detector comprises:
an envelope detector configured to receive the communication signal and the interfering signal and determine a power of the interfering signal;
a variable gain amplifier configured to receive the output of the envelope detector and provide an analog control signal;
an analog-to-digital converter (ADC) configured to receive the analog control signal and generate a digital control signal based on the analog control signal; and
a digital-to-analog converter (DAC) configured to use the digital control signal to control the amount of current flowing through the common gate buffer circuit.

7. The device of claim 1, wherein the interfering signal detector comprises:
a switching device coupled to an adjustable resistive-capacitive (RC) filter network, the switching device configured to receive the communication signal and the interfering signal and determine a power of the interfering signal;
a variable gain amplifier configured to receive the output of the envelope detector and provide an analog control signal;
an analog-to-digital converter (ADC) configured to receive the analog control signal and generate a digital control signal based on the analog control signal; and
a digital-to-analog converter (DAC) configured to use the digital control signal to control the amount of current flowing through the common gate buffer circuit.

8. The device of claim 7, wherein the adjustable resistive-capacitive (RC) filter network is adjusted to determine a frequency to be measured for the interfering signal.

9. A method comprising:
providing a common gate buffer circuit configured to receive a communication signal;
providing a control signal indicative of the power level of an interfering signal present with the communication signal; and
controlling an amount of current flowing through the common gate buffer circuit based on the control signal.

10. The method of claim 9, further comprising taking an input to the interfering signal detector from any of an input and an output of the common gate buffer circuit.

11. The method of claim 9, further comprising taking an input to the interfering signal detector from an output of an operational amplifier (OP-AMP) located in the common gate buffer circuit.

12. The method of claim 9, further comprising taking an input to the interfering signal detector from an input of the common gate buffer circuit and locating the control circuit at an output of the common gate buffer circuit.

13. A device, comprising:
means for providing a common gate buffer circuit configured to receive a communication signal;
means for providing a control signal indicative of the power level of an interfering signal present with the communication signal; and
means for controlling an amount of current flowing through the common gate buffer circuit based on the control signal.

14. The device of claim 13, further comprising means for taking an input to the interfering signal detector from an input to the common gate buffer circuit.

15. The device of claim 13, further comprising means for taking an input to the interfering signal detector from an output of the common gate buffer circuit.

16. The device of claim 13, further comprising means for taking an input to the interfering signal detector from an output of an operational amplifier (OP-AMP) located in the common gate buffer circuit.

17. The device of claim 13, further comprising means for taking an input to the interfering signal detector from an input of the common gate buffer circuit and the means for controlling an amount of current flowing through the common gate buffer circuit is located at an output of the common gate buffer circuit.

18. The device of claim 13, further comprising:
means for determining a power level of the interfering signal using an envelope detector;
means for receiving the power level of the interfering signal and generating an analog control signal;
means for receiving the analog control signal and generating a digital control signal based on the analog control signal; and
means for using the digital control signal to control the amount of current flowing through the common gate buffer circuit.

19. The device of claim 13, further comprising:
means for determining a power level of the interfering signal using a switching device coupled to an adjustable resistive-capacitive (RC) filter network;
means for receiving the power level of the interfering signal and generating an analog control signal;
means for receiving the analog control signal and generating a digital control signal based on the analog control signal; and
means for using the digital control signal to control the amount of current flowing through the common gate buffer circuit.

20. The device of claim 19, further comprising means for adjusting the adjustable resistive-capacitive (RC) filter network to determine a frequency to be measured for the interfering signal.
